(19) United States
(12) Patent Application Publication
(10) Pub. No.: US 2010/0040851 A1
(43) Pub. Date: Feb. 18, 2010

(54) PAD PRINTING MACHINE AND PRINTING PAD THEREFOR

(75) Inventor: Peter Schroeder, Baiersbronn (DE)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW MORLOCK GMBH, Baiersbronn (DE)

(21) Appl. No.: 12/529,316

(22) PCT Filed: Apr. 18, 2008
(86) PCT No.: PCT/IB08/00975

§ 371 Date: Aug. 31, 2009

(30) Foreign Application Priority Data
Apr. 23, 2007 (DE) 10 2007 019 398.1
May 10, 2007 (DE) 20 2007 006 656.2

(51) Int. Cl. B32B 7/02; B29C 45/14; B41K 1/42

(52) U.S. Cl. 428/217; 264/259; 101/333

(57) ABSTRACT

The invention relates to a pad printing machine and in particular to its pad. The pad consists of at least two resiliently compressible layers, the shore hardness of one layer being different from that of the other.

The present invention relates to a pad printing machine and its pad as defined in the preamble of claim 1.

Pad printing machines are known for instance from WO 2004/113075 A1 and EP 1,053,882 B1.

Printing machine pads are made of a resiliently compressible material. Such a material illustratively is silicone. Illustratively the pad compliance depends on how much oil is contained in the silicone.

Illustratively the pad shore hardness is in the range between 5 and 30. A harder pad allows a more accurate printed image than a softer pad, however it requires more compression.

The object of the present invention is to create an accurate (good) printed image by means of a compression, which is lower than that required for a hard pad, applied by the printing machine to the pad

This objective of the present invention is attained by a pad defined by the features of claim 1.

Moreover the present invention relates to a method for making a pad defined in the claims.

Also the present invention relates to a pad printing machine fitted with at least one pad designed and/or made according to the present invention.

The present invention is elucidated below in relation to the appended drawings of illustrative embodiment modes.

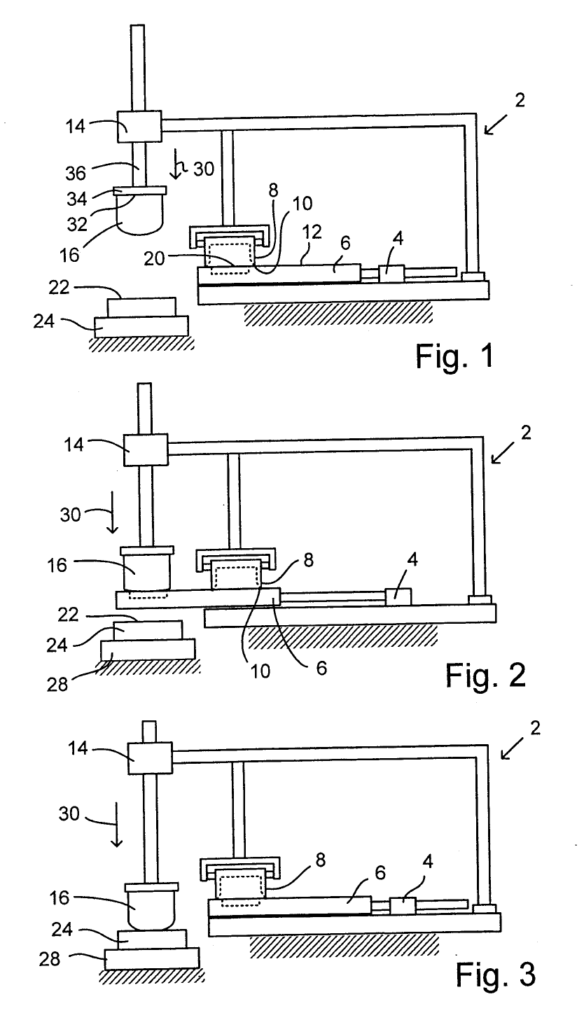

FIG. 1 shows in side view the principle of a pad printing machine when the printing block is receiving ink,

FIG. 2 shows the pad printing machine of FIG. 1 when the pad is absorbing ink,

FIG. 3 shows the pad printing machine of FIG. 1 in the printing state,

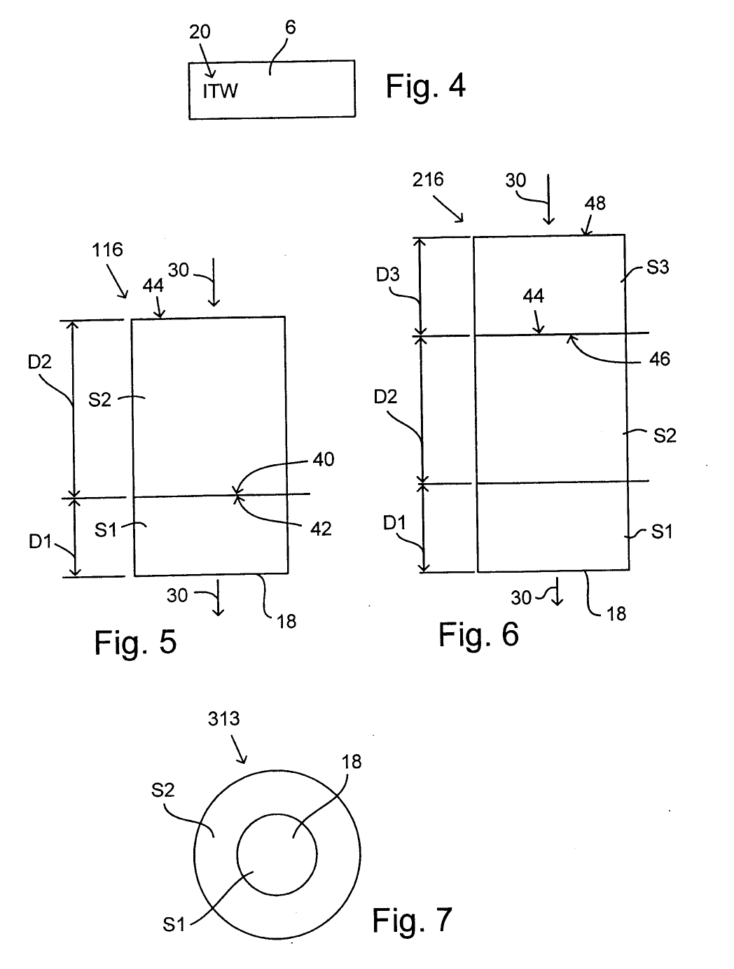

FIG. 4 is a topview on the printing block of FIGS. 1 and 3,

FIG. 5 is a sideview of a special embodiment of the pad of the present invention,

FIG. 6 is a sideview of a further embodiment of a pad of the present invention, and

FIG. 7 is a view of the printing surface of a further embodiment of the tampon of the present invention.

The pad printing machine 2 is schematically shown in sideview in FIG. 1 and contains a drive 4 to move a printing block 6 between a retracted position, indicated in FIGS. 1 and 3, and an extended position shown in FIG. 2. The drive 4 preferably is linear drive, for instance a hydraulic or pneumatic cylinder, through it may also be an electric motor. The pad printing machine 2 contains an ink cup 8 which is inverted, as a result of which the cup edge 10 rests on the printing block surface 12 and acts as a doctor.

The pad printing machine 2 is further fitted with another drive 14 to vertically position a pad 16 so that it may be deposited by its printing surface on an mage zone 20 in the surface 12 of the printing block 6 or alternatively on a surface to be printed 22 of an object 24 being printed. The second drive 14 preferably is also pneumatic or hydraulic, though an electric drive may also be used.

The printing block's image zone 20 contains the image which shall transferred from the printing block 6 to the object 24 being printed, said image being an engraving in the surface 12 of the printing block 6. The expression “image” used herein applies both to any kind of object being represented and any kind of script, lettering, numbering and symbols, for instance the letters “ITW” as shown in FIG. 4.

FIG. 1 shows the pad printing machine 2 when the printing block is receiving ink. In this state, the printing block assumes its retracted position, the ink cup 8 is situated above the image zone 20, and the pad 16 is in an upwardly retracted initial condition higher than that of the printing block 6.

FIG. 2 shows the pad printing machine when the pad is receiving ink. In this case the printing block 6 has shifted forward, its image zone 20 being outside that of the ink cup 8. The pad 16 was moved downward onto the image zone 20 to absorb its ink.

After the pad has received ink as indicated in FIG. 2, the printing block 6 is moved back by its drive 4 into the retracted position shown in FIG. 1.

FIG. 3 shows the printing state of the pad printing machine 2 wherein the printing block 6 is back in the retracted position of FIG. 1, however the pad 16 was moved by its drive 14 down onto the printable surface 22 of the object being printed 24 to transfer the ink and hence the print image it to the print surface 22.

Now the object being printed 24 is configured with its printable surface 22 underneath the pad 16 and in said pad's vertical path, also underneath the horizontal path of the printing block 6.

The present invention is not restricted to the embodiment mode of FIGS. 1 through 3, which are meant to only outline the basic principle of pad printing. In other embodiment modes, for instance, the printing block 6 may be fixed in place and the ink cup 8 may be displaceably configured on the surface 12 of the printing block 6. A support 28 for the object to be printed may be fixed or displaceable.

The pad printing direction 30—along which the pad 16 is forced downward against the print image 20 of the printing block 6 (FIG. 2) to receive ink and then to transfer the ink in the form of the print image to the printable surface 22 of the object to be printed 24 (FIG. 3)—is indicated in the drawings by arrows 30.

The pad printing surface 18 preferably assumes the shape of a hemisphere or a rounded conical tip (FIG. 1) or may be in another shape, for instance being planar, as illustratively shown in FIGS. 5 and 6.

At its affixation end 32, the pad 16 is connected directly or connectable by means of a link 34 such as a flange, to a drive element 36 of the second drive 14.

The pad 16 is made of a resiliently compressible material. This material for instance is porous, for instance a sponge, though having a closed and smooth surface. Silicone is known as such a material. The hardness of silicone may be adjusted by variously admixing oil to it before this silicone is shaped in a casting or molding procedure into a pad. Other materials also may be used to form the pad 16, for instance other plastics.

In the present invention, the pad 16 contains or consists of at least two resiliently compressible layers, one being of a hardness differing from that of the other layer, the layers of different hardnesses being directly adjoining one another and adhering to each other by their own adhesiveness. When preparing these layers, the first layer is made by casting or injection molding and then the other layer is made by casting or injection molding it onto the first layer, these layers adhering to each other or together exhibiting some other adhesion, for instance crosslinking with each other.

In this manner the pad 16 may be constituted by two or more layers of different hardnesses. Examples are shown in FIGS. 5 through 7.

The adhesion between the particular strata also may be implemented by vulcanization.

FIG. 5 shows a pad 116 (being illustrative of the pad 16) consisting of two layers S1 and S2 superposed in the pad printing direction 30. Illustratively the lower layer S1 shown in FIG. 5 constitutes at its underside the pad printing surface 18 and is directly connected (without an interim layer) at its top side 40 to the underside of the top layer S2 by means of the mutual attractions of the layers S1 and S2. One of the two layers S1 or S2 exhibits a higher shore hardness than the other. In one embodiment mode, the harder layer is S1, which constitutes the printing surface 18, the other layer S2 having a smaller shore hardness than the lower layer. In another embodiment mode of the present invention, it is the lower layer S1 which exhibits a smaller shore hardness than the upper layer S2.

The top side 44 of the upper layer S2 is the side connected or connectable to the drive element 36 of a pad printing machine, either directly or by means of a connection element 34 such as a flange 34.

The shore hardness of the harder layer, for instance S1, is at least 10% higher than that of the softer layer, for instance S2. The shore hardness of one of the layer (S1 or S2) also may be substantially harder than only 10% of the other layers S2 (or S1), for instance being twice or three times as hard.

The thickness D1 of the layer S1 fitted with the printing surface 18 as measured in the direction of compression 30 may be as large as, more or less than the thickness D2 of the other layer S2 which comprises the connection side 44.

The minimum of two layers S1 and S2 of different hardnesses preferably is made of the same base material, but contains different proportions/quantities of admixed additive.

Preferably the base material is rubber or a plastic which contains an additive. Even though other plastics also are applicable, silicone is a preferred base material. Preferably the additive is oil.

In other embodiment modes, the layers of different hardness may each consist of a different material, for instance two different kinds of plastics or one layer being a plastic and the other being made of rubber, etc.

Preferably, when manufacturing the pad 16 respectively 116, first the higher shore—hardness layer S1 of is manufactured and then the softer layer S2 is poured or injection molded on it in a manner that the two materials during such casting or injection molding adhere to each other at their interfacing sides 40 and 42, this adhesion then being permanent following the casting or injection molding when the layers S1 and S2 are cooled from such higher temperatures to the ambient one.

The pad 16 or 116 also may consist of more than three layers.

FIG. 6 illustrates a pad 216 of the present invention which may be used as a pad 16 and for instance consists of three layers, namely said layers S1 and S2 and a third layer S3 deposited on the top side 44 of the second layer by casting or injection molding, the downward pointing side 46 of said layer S3 adhering to the upward pointing side 44 of the second layer S2 by means of the above described adhesion forces relating to the mutually adhering sides 40 and 42. The third layer S3 may be the same as or different from either of the layers S1 and S2. Preferably the third layer S3 also is made of a material similar to that of the layers S1 and S2 and preferably and its shore hardness is higher than that of the layer S2. In another embodiment mode the shore hardness of the third layer S3 may be less than that of the second layer S2. The side 48 shown pointing upward in FIG. 6 opposite the direction of compression 30 may be designed to be a connection part or be fitted with a connecting part comprising a connection element 34 for affixation to a drive element 36 (FIG. 1). The thickness D3 of the third layer S3 may be as large as, smaller or larger than the thickness D1 and/or D2 of the first and second layers S1 respectively S2.

FIG. 7 shows a bottom view of a further pad embodiment mode of the present invention, showing the printing surface 18. In this embodiment mode the two layers S1 and S2 are not superposed in the direction of printing 30, instead they are configured radially to each other, whereby the layer 1 constitutes an axial core of the pad in the said direction 30 and the other layer S2 constitutes a jacket fully and annularly enclosing the core of the layer S1.

In another preferred embodiment mode of the invention, at least one of the layers S1, S2, S3 is different in shore hardness from the shore hardness of the minimum of one of the other layers S2, S3, S1 and its ink/color is different from that of the minimum of one other layer. Preferably the inks of the same shore hardness layers also assume the same color.

Accordingly the different layers can be sensed optically by an operator on account of different colors, these colors furthermore may display the pad position when sorting the pads following their manufacture, and the position of a pad in a printing machine may be detected automatically by a suitably automated device and be correspondingly transduced into control signals. Such different colors also allow automated detection of a pad containing different hardnesses.

Preferably the different layer's colors are implemented not by depositing inks on the outer layer's surfaces but instead by making the layers in different colors. Materials may be used which inherently display a given color, or dyes may be admixed to the pad before or during its manufacture. Pad manufacture preferably shall be by casting or injection molding. In all these options the layers of different colors are made already during pad manufacture.

1. A resiliently compressible pad for a pad printing machine,
characterized
in that it comprises at least two resiliently compressible layers (S1, S2, S3), the shore hardness of one layer differing from that of the other layer, the layers of different shore hardnesses directly abutting each other and being inseparably linked.

2. Pad as claimed in claim 1, characterized in that the minimum of at least two layers (S1, S2, S3) of different hardnesses are made of the same base material but containing different proportions/quantities of an additive.

3. Pad as claimed in claim 2, characterized in that the base material is a rubber or a plastic, the additive preferably being an oil.

4. Pad as claimed in claim 3, characterized in that the base material is a silicone.

5. Pad as claimed in claim 1, characterized in that the layers are of different hardnesses and different materials.

6. Pad as claimed in claim 1, characterized in that the shore hardness of the harder layer is at least 10% higher than that of the adjoining softer layer.

7. Pad as claimed in claim 1, characterized in that the shore hardness of the harder layer is at least twice or more that of the adjacent softer layer.

8. Pad as claimed in claim 1, characterized in that the harder layer (S1) constitutes the pad printing surface (18).

9. Pad as claimed in claim 1, characterized in that the minimum of one layer (S1, S2, S3) of a shore hardness different from the minimum of one other layer (S2, S3, S1) exhibits another color than the minimum of one other layer.

10. A method for manufacturing a pad as claimed in claim 1,
characterized
in that the minimum of two layers (S1, S2, S3) are manufactured consecutively in a casting or injection molding procedure, the layer manufactured later being poured or injection-molded onto the layer manufactured earlier, adhesion by means of their intrinsic adhesive forces being set up between the two adjoining layers provided one or both of the layers are still in an appropriately warm state to generate adhesion.

11. Method as claimed in claim 10, characterized in that the harder layer (S1) is manufactured first and then the softer layer (S2), the softer stratum (S2) being poured or injection-molded onto the harder layer (S1).

12. Pad printing machine containing at least one or several pads manufactured in the manner claimed in claim 1.
